(19) United States
(12) Patent Application Publication
(10) Pub. No.: US 2005/0160055 A1
(43) Pub. Date: Jul. 21, 2005

(54) Method and device for dividing a population of individuals in order to predict modalities of a given target attribute

(75) Inventor: Marc Boulle, Tregastel (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM SA, Paris (FR)

(21) Appl. No.: 11/031,532

(22) Filed: Jan. 10, 2005

(30) Foreign Application Priority Data
Jan. 9, 2004 (FR) 04 00179

(51) Int. Cl. G06F 15/18; G06F 7/00; G06F 17/00

(52) U.S. Cl. 706/12; 707/104.1

(57) ABSTRACT

A population of individuals defined by at least one source attribute and one target attribute on a database is divided to predict modalities of a given target attribute. Using a region partition model, there are calculated values of a discrete distribution model of independent regions obtained for a plurality of numbers of regions and/or a plurality of numbers of individuals in the respective regions and/or a plurality of numbers of individuals with the same target modality in the regions. The region partition model is such that the distributions of the individuals over each region are independent of one another and the distribution of the individuals over each region is defined by the number of individuals in the region.

### CROSS-REFERENCE TO RELATED APPLICATION

This application claims the benefit of priority under 35 U.S.C. §119 of French Application No. 04 00179, filed Jan. 9, 2004, the entire disclosure of which is hereby incorporated herein by reference.

### FIELD OF THE INVENTION

The present invention concerns a method and device for dividing a population of individuals characterised by at least one source attribute and one target attribute on a database in order to predict modalities of a given target attribute.

The invention especially finds application in the statistical use of data and, in particular, in the supervised learning field.

### BACKGROUND ART

Statistical data analysis, or Data Mining, can require considerable effort with the appearance these last few years of very large databases. Data Mining aims, in general terms, to explore, classify, and extract underlying association rules within a database. It is used, in particular, to construct classification or prediction models. Classification makes it possible, within a database, to identify categories from combinations of attributes, and then to arrange the data according to the categories.

Thus, one of the objectives of so-called “supervised” Data Mining is the construction of a predictive model aimed at predicting a predetermined attribute. The construction of a predictive model is often based on an attribute selection step. This selection consists of identifying, from among the attributes of the database under consideration, the attribute or attributes which have the strongest statistical dependency in conjunction with a target attribute and of describing this dependency.

For example, an individual is one product among the set of similar products forming a population.

As another example, a product is a mobile telephone whose attributes are, for example, the reference, the functionalities it has, its date of manufacture, the place of manufacture thereof, the manufacturer, the geographical area in which it was sold, and perhaps even the type of subscription associated therewith. For example, the target attribute is an operating fault thereof.

The prediction of this target attribute then makes it possible to detect the risks of failure of the telephone handsets as a function of the source attributes and to be able to modify mobile telephones so as to reduce these failures.

An individual can also be a customer to a service. Customer source attributes are, for example, age, profession, social status, income, and place of residence. The target attribute is, for example, customer loyalty to a service to which he subscribes.

An individual can also be a weather station whose various readings constitute the attributes of the weather station. From these source attributes, the present invention can thus predict target attributes such as possible deterioration of weather conditions and perhaps even natural disasters such as floods.

An attribute takes on various values. These values, conventionally called “modalities,” can be numerical or symbolic.

Certain supervised Data Mining methods require a partition into regions of the attribute modalities. These regions are known as “groups” when the attributes are symbolic and “intervals” when the attributes are numerical. All the modalities of one or more attributes are thus grouped into a finite number of regions by searching for a compromise between the informational value and the predictive value of the partition formed.

Certain supervised Data Mining methods require “discretization” of the numerical attributes. Discretization of a numerical attribute as used herein means splitting into a finite number of regions the domain of the modalities taken on by an attribute. If the domain in question is a range of continuous modalities, the discretization will be expressed by a quantization of this range. If the domain already consists of ordered discrete modalities, the function of the discretization will be to group these modalities together into groups of consecutive modalities.

Discretization of numerical attributes is a subject dealt with widely in the literature.

Two types of discretization methods are distinguished: top-down methods and bottom-up methods. Top down methods start from a complete interval to be discretized and search for the best point of splitting the interval by optimising a predetermined criterion.

Bottom-up methods start from elementary intervals and search for the best merging of two adjacent intervals by optimising a predetermined criterion.

In both cases, they are applied iteratively until a stop criterion is satisfied.

Certain of these methods require user parameterisation in order to modify the behaviour of the criterion for choosing the discretization point or to fix a threshold for stopping the method. This is because the discretization methods must guarantee a good compromise between informational quality, i.e., the homogeneity of intervals with regard to the target attribute to be predicted, and statistical quality, i.e., the presence in the intervals of a sufficient number of modalities to provide an effective generalisation.

A number of discretization methods are inspired by information theory and, in particular, the Minimum Description Length (MDL) principle.

Among these methods, the method described by U. Fayyad and K. Irani in, “On the handling of continuous-valued attributes in decision tree generation,” published in the Journal Machine Learning 8: 87-102 (1992), uses a criterion for measuring the amount of information in an interval with no splitting, and in an interval with splitting. Based on the Minimum Description Length (MDL) principle, this method is a top-down discretization method. It starts from a complete interval, evaluates all potential splits, and retains the one in which the amount of resulting information is a minimum. If the amount of information is less than that in the initial interval, the split is retained, and the algorithm is applied recursively to the two intervals obtained. This discretization method is based on an evaluation criterion and an optimisation algorithm, which implicitly define an apriorism favouring certain models, either by the criterion or by optimisation heuristics. This same method also focuses on the problem of coding a model and on the exceptions to this model.

Another method based on the MDL principle was proposed by B. Pfahringer in “Compression-Based Discretization of Continuous Attributes,” during the Twelfth International Conference on Machine Learning in 1995.

This method uses a global discretization evaluation criterion. First, a method such as that proposed by J. Catlett in “On changing continuous attributes into ordered discrete attributes,” is used to generate a set of potentially advantageous splitting points. This method is a top-down method, recursively searching for the best bipartition of an interval by maximising an information-saving criterion. This method is applied so as to obtain 32 initial intervals. Having obtained these intervals, an algorithm is applied in order to search for the best discretization by optimising the MDL criterion for the interval boundaries.

When the target attribute comprises two modalities, the total cost of the discretization according to this algorithm, is equal to:

$$Discretization = ( {I}_{max} - 1 ) \cdot ent ( I - 1 , {I}_{max} - 1 ) + \\ Lent ( {I}_{1} , I ) + {\sum }_{i} {n}_{i} \cdot ent ( {n}_{imaj} , {n}_{i} )$$

wherein Iₘₐₓ the maximum number of intervals, I the number of intervals, I₁ the number of intervals for which the majority modality is the modality 1, ent(k,n) is the amount of information corresponding to the choice of k possibilities from amongst n and is given by the formula ent(k,n)=−(k/n)log(k/n)−(1−k/n)log(1−k/n), nᵢ being the number of individuals in the interval i, and nᵢₘₐⱼ being the number of individuals which have the majority modality of the interval i.

The total discretization cost breaks down into the sum of three terms. The first term
(Iₘₐₓ 1).ent(I−1, Iₘₐₓ−1)
represents the coding of the boundaries between the intervals and represents the evaluation of the partitions. The second term, I.ent(I₁, I), represents the coding of the majority modalities of the intervals and, therefore, depends on both the total number of intervals and the number of intervals having the first target modality as the majority modality. The third term

$${\sum }_{i} {n}_{i} \cdot ent ( {n}_{imaj} , {n}_{i} )$$

represents the coding of examples of the majority modality in each interval and represents the evaluation of an interval.

The dependency of the second term with respect to the total number of intervals, which is an item of global information of the partition, and with respect to the number of intervals having the first target modality as the majority modality, which is an item of local information dependent upon each interval, means that the criterion used in this method cannot be broken down over the intervals.

Thus, it is not possible for such a method to break down this criterion over the intervals and, therefore, to process a first interval and then a second interval without the processing of the second interval influencing the first interval.

The foregoing methods, although using good quality discretization choice criteria, are not optimal. These methods are based on evaluation criteria and on optimisation algorithms which implicitly define an apriorism favouring certain models, either by the criterion they use or by the optimisation heuristics.

The use of discretization choice criteria which cannot be broken down does not allow the determination of an efficient and optimal optimisation algorithm and thus an optimal use of data.

The aim of the present invention is to solve the drawbacks of the prior art by proposing a method of dividing on a database a population of individuals defined by at least one source attribute and one target attribute in order to predict modalities of a given target attribute which is not only optimal, based on an apriorism explicitly defined by the user, but can also be broken down over intervals.

### SUMMARY OF THE INVENTION

To that end, according to a first aspect, the invention proposes a method of dividing on a database a population of individuals defined by at least one source attribute and one target attribute in order to predict modalities of a given target attribute, a modality of the target attribute being associated with an individual, wherein the population of individuals is divided into a partition of regions, each region comprising a number n of individuals, there being associated with each region the numbers of individuals with the same target modality contained in the region, the method comprising the steps of:
calculating, using a region partition model, values of a discrete distribution model of independent regions obtained for a plurality of numbers of regions and/or a plurality of numbers of individuals contained in the respective regions and/or a plurality of numbers of individuals with the same target modality contained in the regions, the region partition model being such that the distributions of individuals over each region are independent of one another, and the distribution of individuals over each region is defined by the number of individuals per target modality in the region;
determining, from among the calculated values, the minimum value of the model; and
dividing the population of individuals into a partition of regions according to (a) number of regions, (b) number of individuals contained in the regions, and (c) number of individuals with the same target modality contained in the regions corresponding to the minimum value calculation.

Correlatively, the invention proposes a device for dividing on a database a population of individuals defined by at least one source attribute and one target attribute in order to predict modalities of a given target attribute, a modality of the target attribute being associated with an individual, wherein the population of individuals is divided into a partition of regions, each region comprising a number of individuals, there being associated with each region the numbers of individuals with the same target modality contained in the region, the device comprising a processor arrangement for:
calculating, using a region partition model, values of a discrete distribution model of independent regions obtained for a plurality of numbers of regions and/or a plurality of numbers of individuals contained in the respective regions and/or a plurality of numbers of individuals with the same target modality contained in the regions, the region partition model being such that the distributions of individuals over each region are independent of one another, and the distribution of individuals over each region is defined by the number of individuals per target modality in the region;
determining, from among the calculated values, the minimum value of the model; and
dividing the population of individuals into a partition of regions according to (a) number of regions, (b) number of individuals contained in the regions, and (c) number of individuals with the same target modality contained in the regions corresponding to the minimum value calculation.

Thus, by using a region partition model such that the distributions of individuals over each region are independent of one another and the distribution of individuals over each region is defined by the number of individuals per target modality in the region, it is possible to determine a partition into regions of a population of individuals in an optimal manner while, at the same time, having a determination algorithm of limited calculation complexity.

Moreover, by describing the region partition model, it is then possible to allow optimal learning for this region partition model.

According to another aspect of the invention, the attributes are symbolic attributes, and the region partition model is such that the number of regions is equiprobable between one and the number of modalities of the source attribute; for a given number of regions, all the divisions of the individuals into a predetermined number of regions are equiprobable; and, for a given region, all the distributions of the modalities of the target attribute are equiprobable.

Thus, by using such a region partition model, it is possible to define an optimisation criterion which is reliable and which makes it possible to find the optimal solution for an apriorism on the explicitly defined models.

Moreover, such a region partition model simplifies the complexity of the target attribute prediction algorithm.

According to another aspect of the invention, the values of a discrete distribution model of independent regions are calculated by using the formula:

$$Value ( IGDD ) = log B + {\sum }_{k = 1}^{K} log ( {C}_{n , + J - 1}^{J - 1} ) + \\ {\sum }_{k = 1}^{K} log ( {n}_{k} ! / {n}_{k , 1} ! {n}_{k , 2} ! … {n}_{k , J} ! )$$

in which n is the number of individuals, J is the number of modalities of the target attribute, I is the number of modalities of the source attribute, nᵢ is the number of individuals for a given source modality, nᵢⱼ is the number of individuals for a modality of the given source attribute and a modality of the given target attribute, K is the number of regions, nₖⱼ is the number of individuals which have the target modality j in the region k, and B is the number of partitions of I modalities of the source attribute in K regions.

Thus, this formula makes it possible to obtain a stop criterion for an optimisation algorithm which can be broken down over the intervals. The use of a parametric definition of the space of the models then makes it possible to calculate exactly the probabilities of the models and data knowing the models. This calculation leads to an evaluation criterion for a discretization or a grouping, the minimum of which corresponds to the discretization or the grouping which is optimal in the Bayes sense.

According to another aspect of the invention, the attributes are numerical attributes and the region partition model is such that the number of regions is equiprobable between one and the number of individuals, for a given number of regions all the divisions of the individuals into a predetermined number of regions are equiprobable and, for a given region, all the distributions of the modalities of the target attribute are equiprobable.

According to another aspect of the invention, the values of a discrete distribution model of independent regions are calculated using the formula:

$$Value ( IIDD ) = log ( {C}_{n + r - 1}^{I - 1} ) + {\sum }_{i = 1}^{J} log ( {C}_{{n}_{i} + J - 1}^{J - 1} ) + \\ {\sum }_{i = 1}^{I} log ( {n}_{i} ! / {n}_{i , 1} ! {n}_{I , 2} ! … {n}_{i , J} ! )$$

in which n is the number of individuals, J is the number of modalities of the attribute, I is the number of regions, nᵢ is the number of individuals in a given region i, and nᵢⱼ is the number of individuals for a modality of the source attribute in the given region i.

Thus, this formula makes it possible to obtain a stop criterion for an optimisation algorithm which can be broken down over the intervals. The use of a parametric definition of the space of the models then makes it possible to calculate exactly the probabilities of the models and data knowing the models. This calculation leads to an evaluation criterion for a discretization or a grouping, the minimum of which corresponds to the discretization or the grouping which is optimal in the Bayes sense.

According to another aspect of the invention, the attributes are numerical attributes and the region partition model is such that the number of regions is equiprobable between one and the number of individuals, and for a given number of partitions, all the partitions into regions of the individuals and all the distributions of the modalities of the target attribute for these regions are equiprobable.

According to another aspect of the invention, the values of a discrete distribution model of independent regions are calculated using the formula:

$$Value ( IIDD ) = log ( {C}_{n + I , J - 1}^{I , J - 1} ) + {\sum }_{i = 1}^{I} log ( {n}_{i} ! / {n}_{i , 1} ! {n}_{i , z} ! … {n}_{i , J} ! )$$

in which n is the number of individuals, J is the number of modalities of the target attribute, I is the number of regions, nᵢ is the number of individuals in a given region i and nᵢⱼ is the number of individuals for a modality of the target attribute in the given region i.

Thus, this formula makes it possible to obtain a stop criterion for an optimisation algorithm which can be broken down over intervals. The use of a parametric definition of the spaced of the models then makes it possible to calculate exactly the probabilities of the models and data knowing the models. This calculation leads to an evaluation criterion for a discretization or a grouping, the minimum of which corresponds to the discretization or the grouping which is optimal in the Bayes sense.

According to another aspect of the invention, the attributes are numerical attributes, and the region partition model is such that all the partitions into regions are equiprobable, irrespective of the number of regions, and, for a given region, all the modality distributions are equiprobable.

According to another aspect of the invention, the region partition model is such that all the regions comprise the same number of individuals nᵢ.

According to another aspect of the invention, a range of variation of the modalities of the source attribute is determined, and the region partition model is such that in the partition into regions, the regions have the same range of variation of the modalities of the source attribute.

According to another aspect of the invention, the values of a discrete distribution model of independent regions are calculated using the formula:

$$Value ( IIDD ) = {\sum }_{i = 1}^{I} log ( {C}_{n , + J - 1}^{J - 1} ) + {\sum }_{i = 1}^{I} log ( {n}_{i} ! / {n}_{i , 1} ! {n}_{i , 2} ! … {n}_{i , J} ! )$$

in which J is the number of modalities of the target attribute, I is the number of regions, nᵢ is the number of individuals in a given region i, and nᵢⱼ is the number of individuals for a modality of the target attribute in the given region i.

Thus, this formula makes it possible to obtain a stop criterion for an optimisation algorithm which can be broken down over the intervals. The use of a parametric definition of the space of the models then makes it possible to calculate exactly the probabilities of the models and data knowing the models. This calculation leads to an evaluation criterion for a discretization or a grouping, the minimum of which corresponds to the discretization or the grouping which is optimal in the Bayes sense.

According to another aspect of the invention, the attributes are numerical attributes and the region partition model is such that all the discretization models are equiprobable irrespective of the number of regions, the partition into regions and the distribution of modalities by interval.

According to another aspect of the invention, the values of a discrete distribution model of independent regions are calculated using the formula:

$$Value ( IIDD ) = {\sum }_{i = 1}^{I} log ( {n}_{i} ! / {n}_{i , 1} ! {n}_{i , 2} ! … {n}_{i , J} ! )$$

in which I is the number of regions, nᵢ is the number of individuals in a given region i and nᵢⱼ is the number of individuals for a modality of the target attribute in the given region i.

Thus, this formula makes it possible to obtain a stop criterion for an optimisation algorithm which can be broken down over intervals. The use of a parametric definition of the space of the models then makes it possible to calculate exactly the probabilities of the models and data knowing the models. This calculation leads to an evaluation criterion for a discretization or grouping, the minimum of which corresponds to the discretization or the grouping which is optimal in the Bayes sense.

According to another aspect of the invention, the calculation of values of a discrete distribution model of independent regions is performed using a region partition model, and the determination of the minimum value of the model is performed using an optimal optimisation algorithm or a bottom-up discretization algorithm or a top-down discretization algorithm.

Thus, the present invention allows the use of algorithms producing an optimal solution with a reasonable calculation cost or the use of algorithms which are efficient in terms of calculation cost and that produce a solution close to the optimal solution.

According to another aspect of the invention, when the calculation of values of a discrete distribution model of independent regions and the determination of the minimum value of the model are performed using a bottom-up algorithm, the method also comprises the following steps performed on the region partition:
merging adjacent regions in pairs iteratively until a single region is formed;
calculating and storing, for each merge, the value of the discretization model;
determining the minimum value stored;
dividing the population of individuals into a region partition according to (a) number of regions, (b) number of individuals contained in the regions, and (c) number of individuals with the same modality contained in the regions corresponding to the minimum value calculation; and
modifying the region partition by simultaneously evaluating divisions of intervals into two intervals, changes of boundary between two consecutive intervals and the combining of three consecutive intervals into two intervals on the region partition.

According to another aspect of the invention, when the calculation of values of a discrete distribution model of independent regions and the determination of the minimum value of the model are performed using a top-down algorithm, the method also comprises the following steps performed on the region partition:
dividing regions into two regions iteratively until as many regions as individuals are obtained;
calculating and storing, for each division, the value of the discretization model;
determining the minimum value stored;
dividing the population of individuals into a region partition according to (a) number of regions, (b) number of individuals contained in the regions, and (c) number of individuals with the same modality contained in the regions corresponding to the minimum value calculation; and
modifying the region partition by simultaneously evaluating divisions of intervals into two intervals, changes of boundary between two consecutive intervals and the combining of three consecutive intervals into two intervals on the region partition.

Thus, these optimisations make it possible to obtain a near-optimal solution at a limited calculation cost.

The invention also concerns a computer program stored in a memory or on a data medium, said program comprising instructions making it possible to perform the method described previously when it is loaded and executed by a computer system.

The present invention is based on a parametric definition of the space of the discretization or grouping models and on the explicit definition of the a priori distribution of the models in this space.

The use of a parametric definition of the space of the models then makes it possible to calculate exactly the probabilities of the models and data knowing the models. This calculation leads to an evaluation criterion for a discretization or a grouping, the minimum of which corresponds to the discretization or grouping which is optimal in the Bayes sense.

Within the context of the present invention, when the individuals have numerical attributes, the individuals are sorted according to the modalities of the attribute to be discretized. The modalities then constitute a string S of length n equal to the number of individuals to be sorted comprising a sequence of modalities of the target attribute, the target attribute being able to take J different modalities.

According to an aspect of the present invention, a discretization model is considered to be a model having independent intervals with discrete distributions if it is based only on the order of the individuals in the string S representing all the individuals, without taking into account the modalities of the attribute to be discretized, if it allows definition of a partition of the string S into sub-strings representing the individuals in an interval, if the distributions of the individuals over each interval are independent of one another, and if the distribution of the individuals over each interval is defined solely by the number of individuals per target modality over this interval.

Thus, according to this aspect of the present invention, an independent intervals with discrete distributions (IIDD) discretization model is compatible with a string S if the sub-strings corresponding to the intervals defined by the model have a distribution of individuals identical to that defined by the model.

The IIDD discretization model of a string S can be optimal in the Bayes sense only if it is compatible with this string. This is because the probability that a string S which is not compatible with an IIDD model conforms to this model is by definition zero. The importance of this result is that any optimisation algorithm for an IIDD discretization of a string S has only to run through the models compatible with the string S in order to obtain the optimal solution, the choice of distributions by interval being given by the string S.

According to the present invention, any probability distribution concerning the possible implementations of the model is a priori referred to as a discretization model.

For example, and according to a first embodiment of the present invention, a first IIDD discretization model apriorism according to the present invention is based on the following assumptions:
the region partition model is such that the number of regions is equiprobable between one and the number of individuals;
for a given number of regions, all the divisions of individuals into a predetermined number of regions are equiprobable; and
for a given region, all the distributions of modalities of the target attribute are equiprobable.

For an IIDD-type discretization, an apriorism is defined as soon as a probability distribution of its characteristic parameters is known.

Hereinafter, the following notations will be used:
p(I): a priori probability of observing a number of intervals I;
p({nᵢ}): a priori probability of observing all the values nᵢ for a given number of intervals I;
p(nᵢ): a priori probability of observing a value of nᵢ for a given interval i;
p({nᵢⱼ}): a priori probability of observing all the values nᵢⱼ for a given number of intervals I;
p({nᵢⱼ}ᵢ): a priori probability of observing all the values nᵢⱼ of a given interval i.

A model is optimal in the Bayes sense if it is the most probable model knowing the data, which amounts to maximizing the probability p(IIDD/S) for a given string S.

In accordance with the Bayes formula, this amounts to maximising p(IIDD)p(S/IIDD)/p(S).

As p(S) is constant, it is then sufficient to maximise p(IIDD)p(S/IIDD).

Regarding the first term:
p(IIDD)=p(I,{nᵢ},{nᵢⱼ})
p(IIDD)=p(I)p({nᵢ}/I)p({nᵢⱼ}/I,{nᵢ})

As the number of intervals is equiprobably between 1 and n, this gives p(I)=1/n.

For a given number of intervals, all the partitions into intervals are equiprobable. In accordance with the combinatorial enumeration formula for this number of partitions, this gives

$$p ( \{ {n}_{i} \} / I ) = 1 / {C}_{n + I - 1}^{I - 1} .$$

Regarding the third term:
p({nᵢⱼ}/I,{nᵢ})=p({nᵢⱼ}₁{nᵢⱼ}₂, . . . ,{nᵢⱼ}_{I}/I,{nᵢ})

The target value distributions are independent by interval, therefore:

$$p ( \{ {n}_{ij} \} / I , \{ {n}_{i} \} ) = {\prod }_{i = 1}^{I} p ( {\{ {n}_{ij} \}}_{i} / I , \{ {n}_{i} \} )$$

$$p ( \{ {n}_{ij} \} / I , \{ {n}_{i} \} ) = {\prod }_{i = 1}^{I} p ( {\{ {n}_{ij} \}}_{i} / \{ {n}_{i} \} )$$

However, for a given interview I of size nᵢ, the number of possible distributions of nₖ in J number of modalities of the target attribute is equal to

$${C}_{{n}_{i} + J - 1}^{J - 1} .$$

$$p ( \{ {n}_{ij} \} / I , \{ {n}_{i} \} ) = {\prod }_{i = 1}^{I} 1 / {C}_{{n}_{i} + J - 1}^{J - 1}$$

Thus, the following is obtained:

$$p ( IIDD ) = ( 1 / n ) ( 1 / {C}_{{n}_{i} + I - 1}^{I - 1} {\prod }_{i = 1}^{I} 1 / {C}_{{n}_{i} + J - 1}^{J - 1}$$

The probability of observing the string S if it has been expressed in accordance with the IIDD discretization model will-now be evaluated.
p(S/IIDD)=p(S/I,{nᵢ},{nᵢⱼ})

By splitting the string S into I sub-strings Sᵢ of size nᵢ the following is obtained:
p(S/IIDD)=p(S₁, S₂, . . . , S_{I})/I,{nᵢ},{nᵢⱼ})

As the string S has been expressed by an independent intervals discretization model, the probabilities of observing each sub-string Sᵢ are independent of one another and therefore:

$$p ( S / IIDD ) = {\prod }_{i = 1}^{I} p ( {S}_{i} / I , \{ {n}_{i} \} , \{ {n}_{ij} \} )$$

On each sub-string, the observed distribution depends only on the model locally at the corresponding interval, thus:
p(Sᵢ/I,{nᵢ},{nᵢⱼ})=p(Sᵢ/{nᵢⱼ}ᵢ)

If the model of the distribution {nᵢⱼ}ᵢ of the target modalities over the interval is incompatible with the sub-string Sᵢ, the probability of observing Sᵢ knowing that it is expressed by the model is zero.

Hereinafter, only models compatible with the observed string will be considered.

Over a given interval, the model is defined by the number of individuals for each target modality, and all the sub-strings compatible with the model are observable equiprobably. The number of possibilities of sub-strings Sᵢ for a given distribution model derives from the multinomial formula.

It should be noted here that the multinomial formula represents the number of possibilities of dividing up a set of nᵢ individuals into J pairwise disjoint subsets of n individuals.

This therefore gives:

$$p ( {S}_{i} / I , \{ {n}_{i} \} , \{ {n}_{ij} \} ) = 1 / ( {n}_{i} ! / {n}_{i , 1} ! {n}_{i , 2} ! … {n}_{i , J} ! )$$

$$p ( S / IIDD ) = {\prod }_{i = 1}^{I} 1 / ( {n}_{i} ! / {n}_{i , 1} ! {n}_{i , 2} ! … {n}_{i , J} ! )$$

Thus, for a string S, it is therefore necessary to find, amongst the IIDD models compatible with the string S, the one that maximises the following formula:

$$p ( IIDD ) p ( S / IIDD ) = ( 1 / n ) ( 1 / {C}_{n + I - 1}^{I - 1} ) {\prod }_{i = 1}^{I} 1 / {C}_{{n}_{i} + J - 1}^{J - 1}$$

$${\prod }_{i = 2}^{I} 1 / ( {n}_{i} ! / {n}_{i , 1} ! {m}_{i , 2} ! … {n}_{i , J} ! )$$

By taking the inverse of the logarithm of the preceding formula, and eliminating the constant term log(n), this amounts to maximising the criterion:

$$Value ( IIDD ) = log ( {C}_{n + I - 1}^{I - 1} ) + {\sum }_{i - 1}^{I} log ( {C}_{{n}_{i} + J - 1}^{J - 1} ) + \\ {\sum }_{i = 1}^{I} log ( {n}_{i} ! / {n}_{i , 1} ! {n}_{i , 2} ! … {n}_{i , J} ! )$$

Thus, the IIDD discretization model according to the first apriorism is optimal in the Bayes sense if its evaluation by the following formula is a minimum over the set of all the models:

$$Value ( IIDD ) = log ( {C}_{n + I - 1}^{I - 1} ) + {\sum }_{i = 1}^{I} log ( {C}_{{n}_{i} + J - 1}^{J - 1} ) + \\ {\sum }_{i - 1}^{I} log ( {n}_{i} ! / {n}_{i , 1} ! {n}_{i , 2} ! … {n}_{i , J} ! )$$

A discretization evaluation criterion can be broken down over the intervals if:
it allows a global evaluation of the discretization;
it breaks down additively into an evaluation of the partition, depending only on S and i, and an evaluation of each interval depending only on Sᵢ, that is:

$$Discretization ( S , I , \{ {S}_{i} , 1 \leq i \leq I ) ) = Partition ( S , I ) + \\ {\sum }_{i = 1}^{I} Interval ( {S}_{i} )$$
each term of the breakdown is bounded, thus allowing optimisation of the criterion.

According to this example,

$$Partition ( S , I ) = log ( {C}_{n + I - 1}^{I - 1} )$$

$$Interval ( {S}_{i} ) = log ( {C}_{{n}_{i} + J - 1}^{J - 1} ) + log ( {n}_{i} ! / {n}_{i , 1} ! {n}_{i , 2} ! … {n}_{i , J} ! )$$

Thus, the discrelization criterion according to the IIDD discretization model can be broken down over the intervals.

According to a second embodiment of the invention, a second IIDD discretization model apriorism is based on the following assumptions:
the number of intervals is between 1 and n, equiprobably;
for a given number of intervals, all the partitions into intervals of the string to be discretized and all the distributions of the modalities of the target attribute for these intervals are equiprobable.

Thus, the IIDD discretization model according to the second embodiment is optimal in the Bayes sense if its evaluation by the following formula is a minimum over the set of all the models:

$$Value ( IIDD ) = log ( {C}_{n + I , J - 1}^{I , J - 1} ) + {\sum }_{i = 1}^{I} log ( {n}_{i} ! / {n}_{i , 1} ! {n}_{i , 2} ! … {n}_{i , J} ! )$$

This criterion can also be broken down over the intervals, and in this second embodiment:

$$Partition ( S , I ) = log ( {C}_{n + I - 1}^{I - 1} )$$

$$Interval ( {S}_{i} ) = log ( {n}_{i} ! / {n}_{i , 1} ! {n}_{i , 2} ! … {n}_{i , J} ! )$$

According to a third embodiment of the invention, a third IIDD discretization model apriorism is based on the following assumptions:
all the partitions into intervals are equiprobable irrespective of the number of intervals;
for a given interval, all the distributions of the modalities of the target attribute are equiprobable.

According to a fourth embodiment of the invention, a fourth IIDD discretization model apriorism is based on an assumption supplementary to the third embodiment, this assumption being that all the regions comprise the same number of individuals nᵢ.

According to a fifth embodiment of the invention, a fifth IIDD discretization model apriorism is based on an assumption supplementary to the third embodiment, this assumption being that the partition into regions is such that the regions have the same range of variation of the modalities of the source attribute.

Thus, the IIDD discretization model according to the third, fourth and fifth embodiments is optimal in the Bayes sense if its evaluation by the following formula is a minimum over the set of all the models:

$$Value ( IIDD ) = {\sum }_{i = 1}^{x} log ( {C}_{{n}_{i} + J - 1}^{J - 1} ) + {\sum }_{i = 1}^{I} log ( {n}_{i} ! / {n}_{i , 1} ! {n}_{i , 2} ! … {n}_{i , J} ! )$$

This criterion can also be broken down over the intervals, and in this second embodiment:

$$Interval ( {S}_{i} ) = log ( {C}_{{n}_{i} + J - 1}^{J - 1} ) + log ( {n}_{i} ! / {n}_{i , 1} ! {n}_{i , 2} ! … {n}_{i , J} ! )$$

According to a sixth embodiment of the invention, a sixth IIDD discretization model apriorism is based on the following assumptions:
all the discretization models are equiprobable, irrespective of the number of intervals, the partition into intervals and the distribution of the modalities of the target attribute by interval.

Thus, the IIDD discretization model according to the sixth embodiment is optimal in the Bayes sense if its evaluation by the following formula is a minimum over the set of all the models:

$$Value ( IIDD ) = {\sum }_{i = 1}^{I} log ( {n}_{i} ! / {n}_{i , 1} ! {n}_{i , 2} ! … {n}_{i , J} ! )$$

This criterion can also be broken down over the intervals, and in this second embodiment:
Interval (Sᵢ)=log(nᵢ!/n_{i,1}!n_{i,2}! . . . n_{i,J}!)

The evaluation criterion being defined, any one of the previously defined criteria is for example used in an optimisation algorithm such as the one proposed in the publication by Y Lechevallier in 1990 in “Technical report No. 1247, INRIA” and entitled “Search for an optimum partition under constraint of a total nature”.

This algorithm, referred to as OPTD for “Optimal Discretization”, makes it possible to find the optimal cost discretization for a complexity equal to the number n of individuals in the string taken to the power three. For a given additive criterion, this algorithm finds the best partition in fewer than 1 fixed intervals.

A criterion is additive if, for an optimal partition of S into I intervals S₁, S₂, . . . , S_{I}, the partition of (S−S₁) into (I−1) intervals is optimal over S₂ . . . S_{I}.

As the discretization criterion according to the IIDD discretization model can be broken down over the intervals, this is an additive criterion.

This is because,

$$Discretization ( S , I ) = Partition ( S , I ) + {\sum }_{i = 1}^{I} Interval ( {S}_{i} )$$

$$Discretization ( S , I ) = Partition ( S , I ) - Partition ( S - {S}_{1} , I - 1 ) + \\ Interval ( S + Partition ( S - {S}_{1} , I - 1 ) + \\ {\sum }_{i = 2}^{I} Interval ( {S}_{i} )$$

If the cost is optimal for the splitting of S into I intervals, then the above formula shows that the cost is optimal for the splitting of (S−S₁) into (I−1) intervals.

The dynamic programming algorithm, the broad outline of which will be stated below, can therefore be applied.

Let S be the initial set consisting of n individuals.

Let S^{k} be the subset of S consisting of individuals k to n. S=S¹.

In an initialisation step, the best partition of the sets Sₖ into one interval is sought.

Trivially S^{k}=[k,n].

Each following step starts from an initial state in which each set S^{k} is partitioned into I intervals, and the best partition into I+1 intervals is sought.
Let the following be written:

$$Local ( S , I ) = Discretization ( S , I ) - Partition ( S , I ) = {\sum }_{i = 1}^{I} Interval ( {S}_{i} )$$

For a given I, optimising Discretization(S,I) is equivalent to optimising Local(S,I).

It is then easy to calculate the optimal partition into I+1 intervals for each of the sets S^{k} by running through the optimal discretizations into I intervals of the sets S^{k′} for k′>k, which corresponds to an algorithmic complexity which is a function of the number of individuals in the population taken to the power two at each step.

Each step gives The best partition of S=S¹ into I intervals, and its global cost can be evaluated. Having reached the step I, there has thus been found, by storing the best solution encountered, the best discretization in fewer than I intervals.

There are at most n steps, which leads to an algorithmic complexity which is a function of the number of individuals in the population taken to the power three for the search for the optimal partition in fewer than n intervals.

Naturally, other optimisation algorithms can also be used in the present invention.

The GBUD (acronym for “Greedy Bottom Up Discretization”) algorithm can also be used in the present invention. This algorithm is described in the French patent application whose publication number is FR 2825168.

According to this algorithm, using elementary intervals for example each consisting of a single individual, all the possible merges of intervals are envisaged, and the best merge in the sense of the criterion to be optimised is determined. As long as the stop criterion has not been reached, the merge is performed and the algorithm is reiterated.

The GTDD (acronym for “Greedy Top Down Discretization”) algorithm can also be used in the present invention.

This algorithm starts from the initially complete numerical domain, envisages all the splits into two intervals, and evaluates the best split in the sense of the criterion to be optimised. If the stop criterion has not been reached, the split is performed and the algorithm is reiterated.

Each bipartition search in an interval of size n has a complexity equal to the number n of individuals in the string.

This recursive algorithm is particularly adapted in the case of a bipartition evaluation criterion, local to two intervals.

According to the present invention, the GTDD algorithm is adapted to take into account evaluation criteria which can be broken down by interval.

First, the best bipartition into two sub-intervals is sought by evaluating all the potential splitting points, and the split is performed if the global evaluation of the bipartition is better than the evaluation of the initial complete interval.

For a given interval i₁, its best split in the global sense into two sub-intervals i₁ₐ and i_{1b} will be sought. Following this split, the new discretization cost is:

$$Discretization ( {Split}_{{i}_{1}} ) = Partition ( S , I + 1 ) + {\sum }_{i = 1}^{{i}_{i} - 1} Interval ( {S}_{i} ) + \\ Interval ( {S}_{{i}_{1 a}} ) + Interval ( {S}_{{i}_{1 b}} ) + \\ {\sum }_{i = {i}_{1} + 1}^{I} Interval ( {S}_{i} )$$

The variation in the cost following the splitting of the two intervals is:
ΔDiscretization(Splitᵢ)=Partition(S, I+1)−Partition(S, I)+Interval(Sᵢ)+Interval(Sᵢ)−Interval(Sᵢ)
Let ΔPartition(S, I)=Partition(S, I+1)−Partition(S, X).
ΔInterval(Splitᵢ)=Interval(Sᵢ)+Interval(Sᵢ)−Interval(Sᵢ).
This gives ΔDiscretization(Splitᵢ)=ΔPartition(S,I)+ΔInterval(Splitᵢ).

This formula makes it possible to search for the best interval split by evaluating only the variations in the interval costs, and then to evaluate the stop criterion of the algorithm by comparing the variation in the cost of the intervals with the variation in the cost of the partition which itself is independent of the choice of split intervals.

It is then sufficient at each step to store, for each interval of the algorithm, its discretization cost and the variation in this discretization cost following its bipartition. After an interval split, only the two sub-intervals resulting from the split have to be updated in order to prepare for the following step.

When the individuals have symbolic attributes, each individual is also described by at least one modality of the source attribute and one modality of the target attribute. The modalities of a symbolic attribute can be distinguished from one another, but cannot be ordered conventionally, unlike the numerical attributes.

According to the present invention, a grouping model is considered to be an independent groups with discrete distributions model if it allows definition of a partition of the populations of individuals into groups, if the distributions of the modalities of the target attribute in each group are independent of one another and if the distribution of the modalities of the target attribute over each group is defined solely by the frequency of the modalities of the target attribute in this group.

Such a grouping model will hereinafter be referred to as the IGDD model.

According to the present invention, an IGDD grouping model is compatible with a string of individuals if the subsets of individuals corresponding to the groups defined by the model have a distribution of the modalities of the target attribute identical to the one defined by the model and an IGDD grouping model of a string of individuals can be optimal in the Bayes sense only if it is compatible with this string.

According to the present invention, any probability distribution concerning the possible implementations of the model is referred to a priori as a grouping model.

For example, an IGDD grouping model apriorism according to the present invention is based on the following assumptions:
the number K of groups is equiprobably between one and the number I of modalities of the source attribute;
for a given number of groups, all the partitions of the modalities of the source attribute into K groups arc equiprobable;
for a given group, all the distributions of the modalities of the target attribute are equiprobable.

Thus, the IGDD discretization model is optimal in the Bayes sense if its evaluation by the following formula is a minimum over the set of all the models:

$$Value ( IGDD ) = log ( B ( I , K ) ) + {\sum }_{k = 1}^{K} log ( {C}_{{n}_{k} + J - 1}^{J - 1} ) + \\ {\sum }_{k - 1}^{K} log ( {n}_{k} ! / {n}_{k , 1} ! {n}_{k , 2} ! … {n}_{k , J} ! )$$

in which n is the number of individuals, J is the number of modalities of the target attribute, I is the number of modalities of the source attribute, nᵢ is the number of individuals for a given source modality, nᵢⱼ is the number of individuals for a modality of the given source attribute and a modality of the given target attribute, K is the number of regions or groups, nₖⱼ is the number of individuals which have the target modality j in the region or group k, and B(I,K) is the number of partitions of I modalities of the source attribute into K regions or groups or referred to hereinafter as the generalised Bell number.

According to a variant embodiment of the present invention, it is laid down that each group is not empty and in this case the number of partitions of I modalities of the source attribute into K regions is equal to S(n,i): in which S(n,i) is the Stirling number of the second kind.

It should be noted here that the Stirling number of the second kind S(n,k) represents the number of partitions of n individuals into k non-empty parts, while the Bell number B(n) represents the total number of partitions of n individuals.

The notion of generalised Dell number B(n,k) introduced in the present invention is equal to the total number of partitions of n individuals into k possibly empty parts.

### BRIEF DESCRIPTION OF THE DRAWINGS

The characteristics of the invention mentioned above, as well as others, will emerge more clearly from a reading of the following description of an example embodiment, said description being given in connection with the accompanying drawings, amongst which:

FIG. 1 is a block diagram of a device for dividing a population of individuals defined by at least one source attribute and one target attribute on a database in order to predict modalities of a given target attribute;

FIG. 2 is a flow diagram of an algorithm for dividing a population of individuals defined by at least one source attribute and one target attribute on a database in order to predict modalities of a given target attribute;

FIG. 3 is a flow diagram of a post-optimisation algorithm performed by the division device following optimisation according to a GBUD type algorithm; and

FIG. 4 is a flow diagram of a post-optimisation algorithm performed by the division device following optimisation according to a GTDD type algorithm.

### DETAILED DESCRIPTION OF THE DRAWINGS

FIG. 1 depicts the block diagram of a device for dividing a population of individuals defined by at least one source attribute and one target attribute on a database in order to predict modalities of a given target attribute.

The division device 10 is for example a microcomputer.

The division device 10 comprises a communication bus 101 to which there are connected a central processing unit 100, a read-only memory RON 102, a random access memory RAM 103, a screen 104, a keyboard 105, a interface 106 for communication with a telecommunication network 150, a hard disk 108 and a reader/recorder 109 of data on a removable medium.

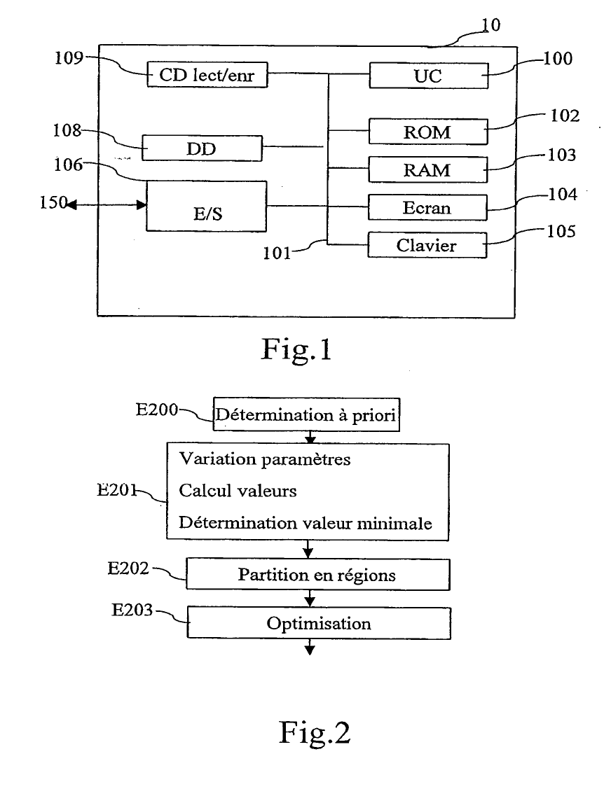

The read-only memory ROM 102 stores amongst other things the programs implementing the invention which will be described later with reference to FIGS. 2, 3 and 4.

The read-only memory ROM 102 also stores the various optimisation criteria of the present invention, and the various optimisation algorithms of the present invention.

In more general terms, the programs according to the present invention are stored in a storage means. This storage means is readable by a computer or a microprocessor 100. This storage means is or is not integrated with the division device 10, and can be removable.

Upon powering up of the division device 10, or when the division software is started, the programs according to the present invention are transferred into the random access memory 103 which then contains the executable code of the invention and the data necessary for implementing the invention.

The division device 10 comprises a screen 104 capable of reproducing information representing the partition into regions of the population in regions according to the present invention.

The division device 10 also comprises a keyboard 105 serving as a human-machine interface. By means of this keyboard 105, the user of the division device 10 selects the discretization criterion from amongst the various optimisation criteria determined by the present invention, and an optimisation algorithm from amongst the optimisation algorithms according to the present invention.

By means of the keyboard 105 and the screen 104, the user selects a database to be processed, a population of individuals to be divided, and a target attribute for which the prediction is to be performed.

Naturally, the keyboard 105 can be replaced or supplemented by a human-machine interface such as a mouse.

The network interface 106 allows the reception of databases to be processed or queries comprising the target attribute for which the prediction is to be performed.

The network interface 106 also allows the transfer by means of the telecommunication network 150 of the prediction on the attribute which has been performed by the processing device.

The hard disk 108 stores the databases used by the present invention for the prediction of a target attribute.

In a variant, the hard disk 108 also stores the programs implementing the invention which will be described later with reference to FIGS. 2, 3 and 4, and the various optimisation criteria of the present invention and the various optimisation algorithms of the present invention.

The reader/recorder 109 of data on a removable storage means is for example a compact disk reader/recorder.

The data reader/recorder 109 is capable of reading the programs according to the present invention for the transfer thereof to the hard disk 108.

The data reader/recorder 109 is also capable of reading databases used for the prediction of a target attribute according to the present invention and of storing the result of the prediction on a removable data medium.

FIG. 2 is a flow diagram of the algorithm performed by the apparatus of FIG. 1 for dividing a population of individuals defined by at least one source attribute and one target attribute on a database in order to predict modalities of a given target attribute.

The step F200 consists of defining a discretization model apriorism.

According to a first embodiment of the present invention, a first IIDD discretization model apriorism according to the present invention is based on the following assumptions:
the region partition model is such that the number of regions is equiprobable between one and the number of individuals,
for a given number of regions, all the divisions of the individuals into a predetermined number of regions are equiprobable and, for a given region,
all the distributions of the modalities of the target attribute are equiprobable.

According to the second embodiment of the invention, a second IIDD discretization model apriorism is based on the following assumptions:
the number of intervals is between 1 and n, equiprobably,
for a given number of intervals, all the partitions into intervals of the string to be discretized and all the distributions of the modalities of the target attribute for these intervals are equiprobable.

According to the third embodiment of the present invention, a third IIDD discretization model apriorism is based on the following assumptions:
all the partitions into intervals are equiprobable irrespective of the number of intervals,
for a given interval, all the symbol distributions are equiprobable.

According to the fourth embodiment of the invention, a fourth IIDD discretization model apriorism is based on an assumption supplementary to the third embodiment, this assumption being that all the regions comprise the same number of individuals nᵢ.

According to the fifth embodiment of the invention, a fifth IIDD discretization model apriorism is based on an assumption supplementary to the third embodiment, this assumption being that the partition into regions is such that the regions have the same range of variation of the modalities of the source attribute.

According to the sixth embodiment of the invention, a sixth IIDD discretization model apriorism is based on the following assumptions:
all the discretization models are equiprobable, irrespective of the number of intervals, the partition into intervals and the distribution of the modalities of the target attribute by interval.

The apriorism used in the present invention having been defined, the following step E201 consists of executing an optimisation algorithm using the formulae described previously and corresponding to the defined apriorism in order to determine the minimum value calculated for the set of possible models.

Knowing J the number of modalities of the attribute, n the number of individuals to be discretized, by calculating the different values Value(IIDD) corresponding to the different variations in the number I of regions, the number nᵢ of individuals in a given region i and the number nᵢⱼ of individuals for a modality of the source attribute in the given region i, it is possible to determine the, division of the population of individuals which is optimal in the Bayes sense.

Conventional algorithms can be used for this determination.

The optimisation algorithm such as the one proposed in the publication by Y. Lechevallier in 1990 in Technical Report No. 1247, INRIA and entitled “Search for an optimal partition under constraint of a total nature” is for example used in the present invention.

The GBUD (acronym for “Greedy Bottom Up Discretization”) algorithm can also be used in the present invention. This algorithm is described in the French patent application whose publication number is FR 2825168.

The GTDD (acronym for “Greedy Top Down Discretization”) algorithm can also be used in the present invention.

The minimum value having been determined, the algorithm goes to the following step E202.

At this step, the population of individuals is divided into a corresponding partition of regions according to the number I of regions, the number nᵢ of individuals in a given region i and the number nᵢⱼ of individuals for a modality of the source attribute in the given region i corresponding to the calculated minimum value.

This operation having been performed, and according to a particular embodiment, a post-optimisation is performed at the step E203 on the region partition.

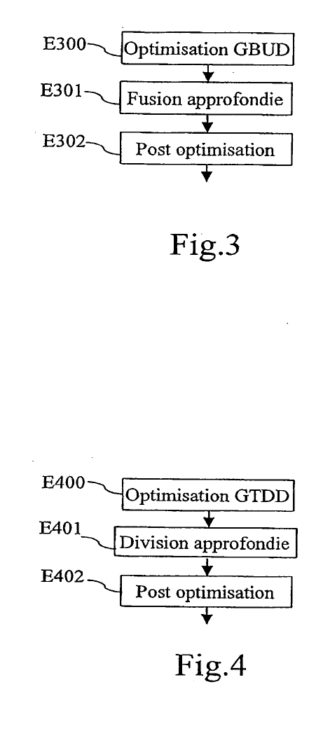

This post-optimisation will be described in more detail with reference to FIGS. 3 and 4.

In the same way as that described previously, when the attributes are symbolic attributes, the present algorithm is capable of dividing a population of individuals where the modalities of the target attributes are two in number and where the groups formed are compatible with the order of the modalities of the source attribute sorted by increasing frequency of appearance.

Similarly, the present algorithm is capable of dividing a population of individuals defined by a set of source symbolic attributes in order to predict modalities of a target attribute.

For this, a symbolic attribute is determined from the set of source attributes. This symbolic attribute is for example determined by performing the Cartesian product of symbolic attributes of the set of source symbolic attributes.

Similarly, the present algorithm is capable of dividing a population of individuals defined by a set of source symbolic and numerical attributes in order to predict modalities of a target attribute.

For this, the numerical attributes are first discretized and a symbolic value is associated with each discretization interval. This symbolic value is for example an index identifying the interval.

The optimisation algorithm such as the GBUD algorithm or Greedy Bottom Up algorithm can also be used in the present invention when the attributes are symbolic. This algorithm is described in the French patent application whose publication number is FR 2825168.

According to a particular embodiment, a pre-optimisation can also be performed prior to the step E201 when the attributes are symbolic attributes.

This pre-optimisation consists essentially of limiting the initial number of modalities I to a number I′=vn. This limitation then makes it possible to significantly reduce the complexity of the optimisation algorithm.

First, the pure modalities of the source attribute, that is to say the source modalities associated with a single type of target modality, are grouped together by modality of the target attribute.

Subsequently, if the number of modalities is still large, the modalities of the source attribute appearing least frequently are grouped together until the number of modalities I′ is obtained.

For example, when a modality is present only once, it is set to the predetermined modality and is associated with a predetermined group comprising all the modalities set to the predetermined modality.

FIG. 3 is a flow diagram of a post-optimisation algorithm performed by the division device following an optimisation according to an OBUD type algorithm.

It should be noted that the use of a GBUD greedy optimisation algorithm may sometimes not provide an optimal solution. This is because, when local minima exist, the GBUD algorithm may stop on one of these local minima.

Moreover, the GBUD algorithm may, under certain conditions, divide the population of individuals into too large a number of partitions, perhaps even an inaccurate determination of the boundaries.

The algorithm as depicted in FIG. 3 aims to solve these problems by proposing a post-optimisation of the GBUD algorithm in several steps denoted E301 and E302. These steps are based on elementary operations for merging adjacent intervals, or for splitting an interval into two sub-intervals.

The step E300 represents the execution of the GBUD algorithm. This step having been performed, the population of individuals is divided into a partition of regions or intervals.

At the following step E301, the intervals obtained previously at the step E300 are merged with one another until a single interval is obtained. At each merging of two intervals, the value of the discretization model is stored.

When the single interval is obtained, the partition into regions corresponding to the stored minimum discretization value is then considered to be the reference partition.

This step makes it possible to avoid a local minimum by accumulating several consecutive merges.

This step consists of forcing the Greedy Top Down algorithm to accept all the interval merges unconditionally until a final single interval is obtained, and of storing the minimum cost discretization encountered during the process. This algorithm makes it possible to come out of a local minimum by accumulating several consecutive merges whilst keeping a reasonable complexity of the GBUD partition algorithm.

This step having been performed, the step E302 consists, from the partition into regions corresponding to the minimum cost discretization determined at the step E301, of a modification of the partition into regions obtained by simultaneously evaluating divisions of intervals into two intervals, changes of boundary between two consecutive intervals and the combining of three consecutive intervals into two intervals.

The aim of the division of an interval into two intervals is to search for the best split of one of the intervals and thus increase the number of intervals in the discretization.

A change of boundary between two consecutive intervals leaves the number of intervals in the discretization invariant.

The combining of three consecutive intervals into two intervals searches for the best re-splitting of three consecutive intervals into two adjacent intervals., and reduces the number of intervals in the discretization by one.

The advantage of performing the three algorithms simultaneously is, on the one hand, improving the convergence time of the algorithm by searching for the best of the improvements amongst all the possible types of improvement and, on the other hand, optimising the updating of the algorithmic structures as soon as an improvement is retained.

FIG. 4 is a flow diagram of a post-optimisation algorithm performed by the division device following an optimisation according to a GTDD type algorithm.

Its should be noted that the use of a GTDD greedy optimisation algorithm may sometimes not provide an optimal solution. This is because, when local minima exist, the GTDD algorithm may stop on one of these local minima.

Moreover, the GTDD algorithm may, under certain conditions, divide the population of individuals into too restricted a number of individuals, perhaps even an inaccurate determination of the boundaries.

The algorithm as depicted in FIG. 4 aims to solve these problems by proposing a post-optimisation of the GTDD algorithm in two steps denoted E401 and E402. These steps are based on elementary operations for merging adjacent intervals and splitting an interval into two sub-intervals.

The step E400 represents the execution of the GTDD algorithm. This step having been performed, the population of individuals is divided into a partition of regions or intervals.

At the following step E401, the intervals obtained previously at the step E400 are divided into two until a number of intervals equal to the total number of individuals in the population is obtained. At each division of an interval into two intervals, the value of the discretization model is stored.

When the number of intervals is equal to the total number of individuals in the population, the partition into regions corresponding to the stored minimum discretization value is then considered to be the reference partition.

This step having been performed, the step E402 consists, from the partition into regions corresponding to the minimum cost discretization determined at the step E401, of a modification of the partition into regions obtained by simultaneously evaluating divisions of intervals into two intervals, changes of boundary between two consecutive intervals and the combining of three consecutive intervals into two intervals.

The aim of the division of an interval into two intervals is to search for the best split of one of the intervals and thus increase the number of intervals in the discretization.

A change of boundary between two consecutive intervals leaves the number of intervals in the discretization invariant.

The combining of three consecutive intervals into two intervals searches for the best re-splitting of three consecutive intervals into two adjacent intervals, and reduces the number of intervals in the discretization by one.

The advantage of performing the three algorithms simultaneously is, on the one hand, improving the convergence V time of the algorithm by searching for the best of the improvements amongst all the possible types of improvement and, on the other hand, optimising the updating of the algorithmic structures as soon as an improved is retained.

When the attributes are symbolic attributes and more particularly when a pre-optimisation has been performed in accordance with that described with reference to FIG. 2, a post-optimisation is preferably performed in order to avoid all the problems related to the presence of local particularities.

A first post-optimisation consists of moving the modalities from one group to another group. For each modality, the cost variation brought about by its transfer to another group is evaluated. These transfers are performed as long as there is an improvement in the evaluation criterion according to the present invention. This is because each descriptive value is thus attracted to its closest group.

A second post-optimisation consists of searching for a new division in terms of partition into groups by deleting a group. The heuristics consists of first searching for the best merging of groups, forcing this merging unconditionally, and then post-optimising the grouping by means of the first post optimisation, by exchanging values between the groups. The new grouping is accepted if there is an improvement in the criterion.

Naturally, the present invention is in no way limited to the embodiments described here, but quite on the contrary includes any variant within the capability of persons skilled in the art.

1. Method of dividing a population of individuals defined by at least one source attribute and one target attribute on a database in order to predict modalities of a given target attribute, a modality of the target attribute is associated with an individual, wherein the population of individuals is divided into a partition of regions, each region comprising a number nᵢ of individuals, with each region there are associated the numbers of individuals with the same target modality contained in the region, the method comprising the steps of:
calculating, using a region partition model, values of a discrete distribution model of independent regions obtained for a plurality of numbers of regions and/or a plurality of numbers of individuals contained in the respective regions and/or a plurality of numbers of individuals with the same target modality contained in the regions, the region partition model being such that the distributions of the individuals over each region are independent of one another and the distribution of the individuals over each region is defined by the number of individuals per target modality in the region;
determining, amongst the calculated values, the minimum value of the model; and
dividing the population of individuals into a partition of regions according to: the number of regions, the number of individuals contained in the regions and the number of individuals with the same target modality contained in the regions corresponding to the minimum value calculation.

2. Method according to claim 1, wherein the attributes are symbolic attributes and the region partition model is such that the number of regions is equiprobable between one and the number of modalities of the source attribute, for a given number of regions all the divisions of the individuals into a predetermined number of regions arc equiprobable and, for a given region, all the distributions of the modalities of the target attribute are equiprobable.

3. Method according to claim 2, wherein the values of a discrete distribution model of independent regions are calculated using the formula:
$$Value ( IGDD ) = log B + {\sum }_{k = 1}^{K} log ( {C}_{{n}_{k} + J - 1}^{J - 1} ) + \\ {\sum }_{k = 1}^{K} log ( {n}_{k} ! / {n}_{k , 1} ! {n}_{k , 2} ! … {n}_{k , J} ! )$$
in which n is the number of individuals, J is the number of modalities of the target attribute, I is the number of modalities of the source attribute, nᵢ is the number of individuals for a given source modality, nᵢⱼ is the number of individuals for a modality of the given source attribute and a modality of the given target attribute, K is the number of regions, nₖⱼ is the number of individuals which have the target modality j in the region k, and B is the number of partitions of I modalities of the source attribute in K regions.

4. Method according to claim 1, wherein the attributes are numerical attributes and the region partition model is such that the number of regions is equiprobable between one and the number of individuals, for a given number of regions all the divisions of the individuals into a predetermined number of regions are equiprobable and for a given region, all the distributions of the modalities of the target attribute are equiprobable.

5. Method according to claim 4, wherein the values of a discrete distribution model of independent regions are calculated using the formula:
$$Value ( IIDD ) = log ( {C}_{n + I - 1}^{I - 1} ) + {\sum }_{i - 1}^{I} log ( {C}_{{n}_{i} + J - 1}^{J - 1} ) + \\ {\sum }_{i - 1}^{I} log ( {n}_{i} ! / {n}_{i , 1} ! {n}_{i , 2} ! … {n}_{i , J} ! )$$
in which n is the number of individuals, J is the number of modalities of the target attribute, I is the number of regions, nᵢ. is the number of individuals in a given region I and n is the number of individuals for a modality of the target attribute in the given region i.

6. Method according to claim 1, wherein the attributes are numerical attributes, and the region partition model is such that the number of regions is equiprobable between one and the number of individuals, and for a given number of partitions all the partitions into regions of the individuals and all the distributions of the modalities of the target attribute for these regions are equiprobable.

7. Method according to claim 6, wherein the values of a discrete distribution model of independent regions are calculated using the formula:
$$Value ( IIDD ) = log ( {C}_{n + I , J - 1}^{I , J - 1} ) + {\sum }_{i = 1}^{I} log ( {n}_{i} ! / {n}_{i , 1} ! {n}_{i , 2} ! … {n}_{i , J} ! )$$
in which n is the number of individuals, J is the number of modalities of the target attribute, I is the number of regions, nᵢ is the number of individuals in given region i and nᵢⱼ is the number of individuals for a modality of the target attribute in the given region i.

8. Method according to claim 1, wherein the attributes are numerical attributes, and the region partition model is such that all the partitions into regions are equiprobable irrespective of the number of regions and, for a given region, all the modality distributions are equiprobable.

9. Method according to claim 8, wherein the region partition model is such that all the regions comprise the same number of individuals n

10. Method according to claim 8, wherein a range of variation of the modalities of the source attribute is determined and the region partition model is such that the partition into regions is such that the regions have the same range of variation of the modalities of the source attribute.

11. Method according to claim 8, wherein the values of a discrete distribution model of independent regions are calculated using the formula:
$$Value ( IIDD ) = {\sum }_{i = 1}^{x} log ( {C}_{{n}_{i} + J - 1}^{J - 1} ) + {\sum }_{i = 1}^{x} log ( {n}_{i} ! / {n}_{i , 1} ! {n}_{i , 2} ! … {n}_{i , J} ! )$$
in which J is the number of modalities of the target attribute, I is the number of regions, nᵢ is the number of individuals in a given region i and nᵢⱼ is the number of individuals for a modality of the target attribute in the given region i.

12. Method according to claim 1, wherein the attributes are numerical attributes, and the region partition model is such that all the discretization models are equiprobable irrespective of the number of regions, the partition into regions and the distribution of modalities by interval.

13. Method according to claim 12, wherein the values of a discrete distribution model of independent regions are calculated using the formula:
$$Value ( IIDD ) = {\sum }_{i = 1}^{τ} log ( {n}_{i} ! / {n}_{i , 1} ! {n}_{i , 2} ! … {n}_{i , J} ! )$$
in which I is the number of regions, nᵢ is the number of individuals in a given region i and nᵢⱼ is the number of individuals for a modality of the target attribute in the given region i.

14. Method according to claim 1, wherein the calculation, using a region partition model, of values of a discrete distribution model of independent regions, and the determination of the minimum value of the model are performed using an optimal optimisation algorithm or a bottom up discretization algorithm or a top down discretization algorithm.

15. Method according to claim 14, wherein, when the calculation of values of a discrete distribution model of independent regions and the determination of the minimum value of the model are performed using a bottom up algorithm, the method also comprises the steps performed on the region partition of:
merging adjacent regions in pairs iteratively until a single region is formed;
calculating and storing, for each merge, the value of the discretization model;
determining the minimum value stored;
dividing the population of individuals into a region partition according to: the number of regions, the number of individuals contained in the regions and the number of individuals with the same modality contained in the regions corresponding to the minimum value calculation; and
modifying the region partition by simultaneously evaluating divisions of intervals into two intervals, changes of boundary between two consecutive intervals and the combining of three consecutive intervals into two intervals on the region partition.

16. Method according to claim 14, wherein, when the calculation of values of a discrete distribution model of independent regions and the determination of the minimum value of the model are performed using a top down algorithm, the method also comprises the steps performed on the region partition of:
dividing regions into two regions iteratively until as many regions as individuals are obtained;
calculating and storing, for each division, the value of the discretization model;
determining the minimum value stored;
dividing the population of individuals into a region partition according to: the number of regions, the number of individuals contained in the regions and the number of individuals with the same modality contained in the regions corresponding to the minimum value calculation; and
modifying the region partition by simultaneously evaluating divisions of intervals into two intervals, changes of boundary between two consecutive intervals and the combining of three consecutive intervals into two intervals on the region partition.

17. Device for dividing a population of individuals defined by at least one source attribute and one target attribute on a database in order to predict modalities of a given target attribute, a modality of the target attribute is associated with an individual, wherein the population of individuals is divided into a partition of regions, each region comprising a number of individuals, with each region there are associated the numbers of individuals with the same target modality contained in the region, and the device comprises a processor arrangement for performing the steps of claim 1.

18. Computer program stored in a memory or on a data medium, said program comprising instructions making it possible for a computer to perform the method of claim 1.
